(19) United States
(12) Patent Application Publication
(10) Pub. No.: US 2026/0109650 A1
(43) Pub. Date: Apr. 23, 2026

(54) METHOD FOR PRODUCING FLUORIDE

(71) Applicant: Panasonic Intellectual Property Management Co., Ltd., Osaka (JP)

(72) Inventors: Takashi KUBO, Hyogo (JP); Kazufumi MIYATAKE, Osaka (JP); Akinobu MIYAZAKI, Osaka (JP)

(21) Appl. No.: 19/423,657

(22) Filed: Dec. 17, 2025

Related U.S. Application Data
(63) Continuation of application No. PCT/JP2024/018920, filed on May 22, 2024.

(30) Foreign Application Priority Data
Jun. 29, 2023 (JP) 2023-107594

(51) Int. Cl. C04B 35/553; C01G 23/02; H01M 10/0562

(52) U.S. Cl. CPC C04B 35/553; C01G 23/02; C04B 2235/445; C04B 2235/6567; C04B 2235/658; H01M 10/0562; H01M 2300/008

(57) ABSTRACT

A method for producing a fluoride of the present disclosure includes firing a mixture, which includes a first ammonium salt containing Ti and F, a second ammonium salt containing Al and F, and having composition different from that of the first ammonium salt, and a lithium-containing compound, in an inert gas atmosphere. The first ammonium salt is represented by (NH₄)ₐTiFₐ₊₄, and a satisfies 0<a≤2. The second ammonium salt is represented by (NH₄)_{b}AlF_{b+3}, and b satisfies 0<b≤3. The lithium-containing compound includes at least one selected from the group consisting of lithium fluoride, lithium carbonate, and lithium nitrate.

This application is a Continuation of PCT/JP2024/018920 filed on May 22, 2024, which claims foreign priority of Japanese Patent Application No. 2023-107594 filed on Jun. 29, 2023, the entire contents of both of which are incorporated herein by reference.

### BACKGROUND OF THE INVENTION

### 1. Field of the Invention

The present disclosure relates to a method for producing a fluoride.

### 2. Description of Related Art

WO 2021/186809 A1 discloses a solid electrolyte material including Li, Ti, M, and F where M is at least one selected from the group consisting of Al and Y. WO 2021/186809 A1 describes that the solid electrolyte material is synthesized, for example, by mechano-chemically reacting raw material powders, which are obtained by mixing LiF, TiF₄, and AlF₃, with each other in a mixing apparatus such as a planetary ball mill, or by firing the above raw material powders in a vacuum sealed tube.

### SUMMARY OF THE INVENTION

In the related art, it is desired to produce a fluoride by an industrially highly productive method.

A method for producing a fluoride of the present disclosure includes firing a mixture, which includes a first ammonium salt containing Ti and F, a second ammonium salt containing Al and F, and having composition different from that of the first ammonium salt, and a lithium-containing compound, in an inert gas atmosphere.

According to the present disclosure, the fluoride can be produced by an industrially highly productive method.

### BRIEF DESCRIPTION OF THE DRAWINGS

FIG. 1A is a flowchart showing an example of a method for producing a fluoride according to a first embodiment.

FIG. 1B is a flowchart showing another example of the method for producing a fluoride according to the first embodiment.

FIG. 1C is a flowchart showing still another example of the method for producing a fluoride according to the first embodiment.

FIG. 1D is a flowchart showing still another example of the method for producing a fluoride according to the first embodiment.

FIG. 1E is a flowchart showing still another example of the method for producing a fluoride according to the first embodiment.

FIG. 2 is a graph showing X-ray diffraction patterns of powders of fired products of Samples 1 to 10.

FIG. 3 is a schematic view for illustrating a pressure-molding die used to evaluate the ionic conductivity of a fluoride.

### DETAILED DESCRIPTION OF THE INVENTION

Hereinafter, embodiments of the present disclosure will be described with reference to the drawings. The following embodiments are each an example, and the present disclosure is not limited to the following embodiments.

### First Embodiment

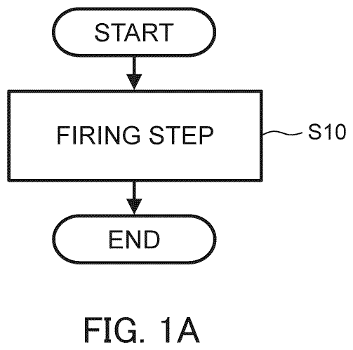

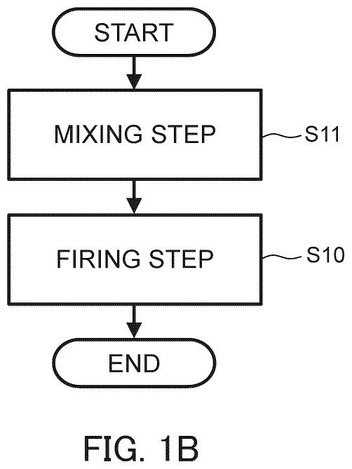

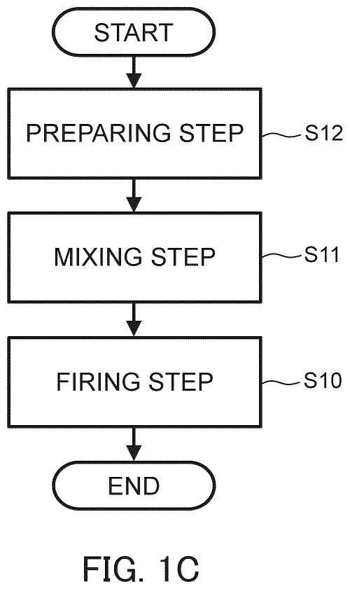

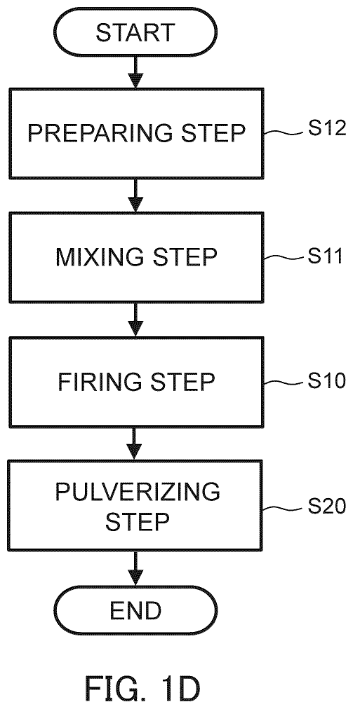

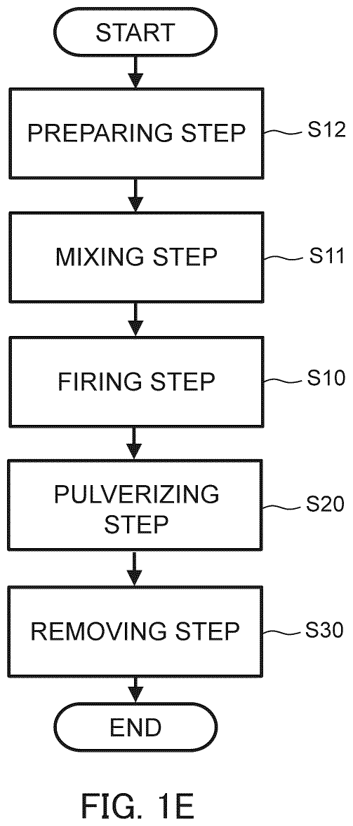

FIG. 1A is a flowchart showing an example of a method for producing a fluoride according to a first embodiment.

The method for producing a fluoride according to the first embodiment includes a firing step S10.

In the firing step S10, a mixture Mx, which includes a first ammonium salt containing Ti and F, a second ammonium salt containing Al and F, and a lithium-containing compound, is fired in an inert gas atmosphere. The second ammonium salt is an ammonium salt having composition different from that of the first ammonium salt.

According to the above configuration, a fluoride can be produced by an industrially highly productive method. For example, materials such as TiF₄ and AlF₃ used in WO 2021/186809 A1 are expensive and poorly available. In contrast, according to the method for producing a fluoride according to this embodiment, a fluoride can be produced by using relatively inexpensive and highly available materials such as the first ammonium salt containing Ti and F, and the second ammonium salt containing Al and F, and by a simple method, that is, simply by firing the mixture Mx in the inert gas atmosphere. Accordingly, a large amount of the fluoride can be produced at low cost.

The fluoride produced by the method for producing a fluoride according to this embodiment may include Li, Ti, Al, and F. The fluoride may consist substantially of Li, Ti, Al, and F. Here, the phrase “the fluoride consists substantially of Li, Ti, Al, and F” means that the molar ratio (i.e., mole fraction) of the sum of the amounts of substance of Li, Ti, Al, and F to the sum of the amounts of substance of all the elements constituting the fluoride is 90% or more. In an example, the molar ratio (i.e., mole fraction) may be 95% or more. The fluoride may consist only of Li, Ti, Al, and F.

The fluoride produced by the method for producing a fluoride according to this embodiment may further include Zr. The fluoride may consist substantially of Li, Ti, Zr, Al, and F. Here, the phrase “the fluoride consists substantially of Li, Ti, Zr, Al, and F” means that the ratio (i.e., mole fraction) of the sum of the amounts of substance of Li, Ti, Zr, Al, and F to the sum of the amounts of substance of all the elements constituting the fluoride is 90% or more. In an example, the ratio (i.e., mole fraction) may be 95% or more. The fluoride may consist only of Li, Ti, Zr, Al, and F.

The fluoride produced by the method for producing a fluoride according to this embodiment may include a solid electrolyte represented by the following composition formula (1). In the composition formula (1), α, β, γ, and δ are each independently a value greater than 0.

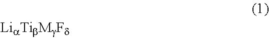

The fluoride produced by the method for producing a fluoride according to this embodiment may include a solid electrolyte represented by the following composition formula (2). In the composition formula (2), M2 is at least one selected from the group consisting of Zr, Ni, Fe, and Cr, m is a valence of M2, and 0.1<x<0.9, 0≤y<0.1, 0≤z<<0.1, and 0.8<b≤1.2 are satisfied.

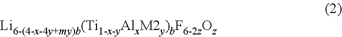

In the composition formula (2), when M2 includes a plurality of types of elements, m is a total value of products of composition ratios of the respective elements and valences of the elements. For example, when M2 includes an element Mel and an element Me2, a composition ratio of the element Mel is a1 and a valence of the element Mel is m1, and a composition ratio of the element Me2 is a2 and a valence of the element Me2 is m2, m is represented by m1×a1+m2×a2.

To further increase its ionic conductivity, in the above solid electrolyte, the ratio of the amount of substance of Li to the sum of the amounts of substance of Ti and Al may be 1.12 or more and 5.07 or less.

The fluoride produced by the method for producing a fluoride according to this embodiment may include a solid electrolyte represented by the following composition formula (3). In the composition formula (3), 0<x<1 and 0<b≤1.5 are satisfied.

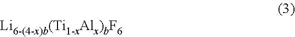

In the composition formula (3), a mathematical relation 0.1≤x≤0.9 may be satisfied to increase the ionic conductivity.

In the composition formula (3), 0.1≤x≤0.7 may be satisfied to further increase the ionic conductivity.

The upper and lower limits of the range of x in the composition formula (3) can be 35 defined by any combination selected from the numerical values of 0.1, 0.3, 0.4, 0.5, 0.6, 0.67, 0.7, 0.8, and 0.9.

In the composition formula (3), a mathematical relation 0.8≤b≤1.2 may be satisfied to increase the ionic conductivity.

The upper and lower limits of the range of b in the composition formula (3) can be defined by any combination selected from the numerical values of 0.8, 0.9, 0.94, 1.0, 1.06, 1.1, and 1.2.

The above solid electrolyte may be crystalline or amorphous.

The fluoride produced by the method for producing a fluoride according to this embodiment may contain an element that is inevitably introduced. Examples of the element include hydrogen, oxygen, and nitrogen. Such an element may be present in a raw material powder of the fluoride or in an atmosphere for producing or storing the fluoride.

The first ammonium salt may be represented by (NH₄)ₐTiFₐ₊₄. In this case, a satisfies 0<a≤2. According to the above configuration, the ionic conductivity of the fluoride can be enhanced. Furthermore, (NH₄)ₐTiFₐ₊₄ can be easily synthesized from inexpensive TiO₂ and NH₄F, and hence the production cost of the fluoride can be reduced.

When the first ammonium salt is represented by (NH₄)ₐTiFₐ₊₄, a may satisfy a=2. According to the above configuration, the ionic conductivity of the fluoride can be further enhanced.

The second ammonium salt may be represented by (NH₄)_{b}AlF_{b+3}. In this case, b satisfies 0<b≤3. According to the above configuration, the ionic conductivity of the fluoride can be enhanced. Furthermore, (NH₄)_{b}AlF_{b+3} can be easily synthesized from inexpensive Al₂O₃ and NH₄F, and hence the production cost of the fluoride can be reduced.

When the second ammonium salt is represented by (NH₄)_{b}AlF_{b+3}, b may satisfy b=3. According to the above configuration, the ionic conductivity of the fluoride can be further enhanced.

In the present disclosure, the lithium-containing compound means a compound of lithium and another element or atomic group. The lithium-containing compound may be an inorganic compound. The lithium-containing compound may include at least one selected from the group consisting of lithium fluoride, lithium carbonate, and lithium nitrate. According to the above configuration, the ionic conductivity of the fluoride can be enhanced.

The firing step S10 is performed in the inert gas atmosphere. An example of the inert gas atmosphere is an atmosphere including a helium gas, an argon gas, a nitrogen gas, or a mixed gas thereof.

In this embodiment, a firing temperature (atmosphere temperature) in the firing step S10 is more than 150° C. and 600° C. or less. According to the above configuration, the materials included in the mixture Mx can be sufficiently reacted, and hence the ionic conductivity of the fluoride can be enhanced. In addition, the thermal decomposition of the fluoride generated by a solid-phase reaction is suppressed. Accordingly, a high-quality fluoride can be obtained.

The firing temperature in the firing step S10 may be 160° C. or more and 600° C. or less, 170° C. or more and 600° C. or less, 180° C. or more and 600° C. or less, 190° C. or more and 600° C. or less, or 200° C. or more and 600° C. or less. According to the above configuration, the ionic conductivity of the fluoride can be further enhanced.

In the firing step S10, a state in which the temperature of the mixture Mx is increased to a predetermined temperature in the inert gas atmosphere may be maintained for a predetermined time or more. A firing time in the firing step S10 is desirably a length that does not cause the composition deviation of a fired product due to the volatilization of the fluoride or the like. The composition deviation of the fired product reduces the ionic conductivity of the fluoride. The firing time in the firing step S10 is, for example, from 1 hour to 48 hours.

In the firing step S10, a powder of the mixture Mx may be put into a container such as a crucible and fired in a heating furnace.

The firing temperature in the firing step S10 may be more than 200° C. and 550° C. or less. According to the above configuration, the ionic conductivity of the fluoride can be further enhanced.

The firing temperature in the firing step S10 may be 300° C. or more and 550° C. or less. According to the above configuration, the ionic conductivity of the fluoride can be further enhanced.

The fired product obtained through the firing step S10 may include a Li₂TiF₆ phase. According to the above configuration, the ionic conductivity of the fluoride can be enhanced.

The fired product including Li₂TiF₆ is easily obtained when the firing temperature is more than 200° C. and 550° C. or less, and is more easily obtained when the firing temperature is 300° C. or more and 550° C. or less.

The fact that the fired product obtained through the firing step S10 includes the Li₂TiF₆ phase can be recognized by, for example, measuring the X-ray diffraction of the fired product. Specifically, the fact that the fired product includes the Li₂TiF₆ phase can be recognized by observing reflections originating from tetragonal Li₂TiF₆ belonging to a space group P4₂/mnm in an X-ray diffraction pattern.

Although not shown, the fired product taken out of the container after the firing step S10 may be pulverized. For example, the fired product may be pulverized with a pulverizing implement such as a mortar or a mixer.

FIG. 1B is a flowchart showing another example of the method for producing a fluoride according to the first embodiment.

As shown in FIG. 1B, the method for producing a fluoride according to the first embodiment may further include a mixing step S11.

The mixing step S11 is performed before the firing step S10. In the mixing step S11, the first ammonium salt containing Ti and F, the second ammonium salt containing Al and F, and the lithium-containing compound serving as raw materials are mixed. According to the above configuration, a uniformly mixed mixture Mx can be obtained. The mixture Mx is fired in the inert gas atmosphere in the firing step S10.

A mixing method is not limited, and a known mixing implement or mixing apparatus may be used. Examples of the mixing implement or mixing apparatus include a ball mill, a pot mill, a V-type mixer, a double cone mixer, and an automatic mortar.

For example, in the mixing step S11, the respective powders of the first ammonium salt, the second ammonium salt, and the lithium-containing compound may be mixed. In this case, the powdery mixture Mx may be fired in the firing step S10.

For example, the powdery mixture Mx obtained through the mixing step S11 may be molded into a pellet shape by uniaxial pressing. In this case, the pellet-shaped mixture Mx may be fired in the firing step S10.

In the mixing step S11, the mixture Mx may be obtained by further mixing, in addition to the first ammonium salt, the second ammonium salt, and the lithium-containing compound, another raw material different from these raw materials.

In the mixing step S11, the mixture Mx may be obtained by mixing a material including the first ammonium salt as a main component, a material including the second ammonium salt as a main component, and a material including the lithium-containing compound as a main component. In the present disclosure, the term “main component” means a component present in the largest amount in mass ratio.

In the mixing step S11, the first ammonium salt, the second ammonium salt, and the lithium-containing compound may be mixed to have a desired molar ratio.

In consideration of a composition change in the firing step S10, the mixing ratio of the first ammonium salt, the second ammonium salt, and the lithium-containing compound may be adjusted in advance so that the composition change is canceled out.

FIG. 1C is a flowchart showing still another example of the method for producing a fluoride according to the first embodiment.

As shown in FIG. 1C, the method for producing a fluoride according to the first embodiment may further include a preparing step S12.

The preparing step S12 is performed before the mixing step S11. In the preparing step S12, materials such as the first ammonium salt, the second ammonium salt, and the lithium-containing compound are prepared.

In the preparing step S12, the materials such as the first ammonium salt, the second ammonium salt, and the lithium-containing compound may each be prepared by synthesis. A commercially available product may be used as each of the materials such as the first ammonium salt, the second ammonium salt, and the lithium-containing compound. The commercially available product is desirably a material having a purity of 99% or more. A dried material may be used as the material. The shape of the material is not particularly limited. The shape of the material may be, for example, powdery or massive. The massive material may be pulverized to provide a powdery material. The shape of a particle in the powdery material is not particularly limited and is, for example, spherical, ellipsoidal, fibrous, or flaky. Each material may be crystalline or amorphous.

The preparing step S12 may include a first ammonium salt synthesizing step S121. According to the above configuration, the production cost of the fluoride can be reduced.

In the first ammonium salt synthesizing step S121, the first ammonium salt represented by (NH₄)ₐTiFₐ₊₄ may be synthesized by a reaction between TiO₂ and NH₄F. In this case, a satisfies 0<a≤2. According to the above configuration, (NH₄)ₐTiFₐ₊₄ can be easily synthesized from inexpensive TiO₂ and NH₄F, and hence the production cost of the fluoride can be reduced.

An example of the first ammonium salt synthesizing step S121 is described below. For example, TiO₂ and NH₄F are mixed so that a mixed molar ratio of TiO₂ to NH₄F is 1:6. A product represented by (NH₄)ₐTiFₐ₊₄ (a=2) is obtained by firing the resulting mixture in a temperature range of from 100° C. to 200° C. NH₄F may be mixed in excess with respect to TiO₂ in order to stably advance the above reaction. For example, the excess amount of NH₄F with respect to TiO₂ may be from 5 mol % to 15 mol %. The above firing may be performed in an inert gas atmosphere or in a reduced pressure atmosphere.

The preparing step S12 may include a second ammonium salt synthesizing step S122. According to the above configuration, the production cost of the fluoride can be reduced.

In the second ammonium salt synthesizing step S122, the second ammonium salt represented by (NH₄)_{b}AlF_{b+3} may be synthesized by a reaction between Al₂O₃ and NH₄F. In this case, b satisfies 0<b s 3. According to the above configuration, (NH₄)_{b}AlF_{b+3} can be easily synthesized from inexpensive Al₂O₃ and NH₄F, and hence the production cost of the fluoride can be reduced.

An example of the second ammonium salt synthesizing step S122 is described below. For example, Al₂O₃ and NH₄F are mixed so that a mixed molar ratio of Al₂O₃ to NH₄F is 1:12. A product represented by (NH₄)_{b}AlF_{b+3} (b=3) is obtained by firing the resulting mixture in a temperature range of from 100° C. to 200° C. NH₄F may be mixed in excess with respect to Al₂O₃ in order to stably advance the above reaction. For example, the excess amount of NH₄F with respect to Al₂O₃ may be from 5 mol % to 15 mol %. The above firing may be performed in an inert gas atmosphere or in a reduced pressure atmosphere.

FIG. 1D is a flowchart showing still another example of the method for producing a fluoride according to the first embodiment.

As shown in FIG. 1D, the method for producing a fluoride according to the first embodiment may further include a pulverizing step S20.

The pulverizing step S20 is performed after the firing step S10. In the pulverizing step S20, a fired product B obtained through the firing step S10 is pulverized.

According to the above configuration, the particle diameter of the fluoride can be adjusted.

A pulverization process in the pulverizing step S20 may be a wet pulverization process or a dry pulverization process. The wet pulverization process is a method in which a material is mixed with a solvent and then pulverized mainly by shearing force and friction force. In the wet pulverization process, the surfaces of the particles of the material are scraped to generate small particles. The dry pulverization process is a method in which a dried material is pulverized mainly by impact force in the atmosphere or in an inert gas atmosphere. In the dry pulverization process, the entirety of the particles of the material are divided into a plurality of lumps.

The pulverization process in the pulverizing step S20 may be the wet pulverization process. In this case, the fired product B is pulverized in the solvent in the pulverizing step S20.

The solvent to be used in the wet pulverization process may be an organic solvent or an inorganic solvent such as water.

The specific dielectric constant of the organic solvent may be 2 or more and 70 or less. Phase separation of the resulting fluoride is easily suppressed by using the organic solvent having a specific dielectric constant that falls within the above numerical range. Accordingly, according to the above configuration, a high-quality fluoride can be obtained.

The organic solvent may include at least one selected from the group consisting of y-butyrolactone, propylene carbonate, butyl acetate, and tetralin. The fired product B obtained through the firing step S10 exhibits very good dispersibility with respect to the above organic solvent. Accordingly, according to the above configuration, the ionic conductivity of the fluoride can be enhanced.

In the pulverizing step S20, media for pulverization may be used. The shape of each of the media for pulverization is not particularly limited and may be spherical, barrel-shaped, or the like. The particle diameter of the material after the pulverization significantly depends on the particle diameter of each of the media for pulverization. In this embodiment, for example, when the media for pulverization are spherical, it is desired that the media for pulverization each have a diameter of 1.0 mm or less.

When the media for pulverization are used, the fired product B, the solvent, and the media for pulverization may be put into a container, and the container may be rotated to pulverize the fired product B. A pulverizing method is not particularly limited and may be mechanical pulverization. A method using a pulverizing apparatus such as a roll mill, a pot mill, or a planetary ball mill may be adopted as the pulverizing method. A bead mill that pulverizes the material with the media for pulverization may be used. After the pulverization, the media for pulverization may be separated with a sieve or the like. Pulverization conditions may be appropriately set in accordance with the apparatus to be used.

FIG. 1E is a flowchart showing still another example of the method for producing a fluoride according to the first embodiment. The example shown in FIG. 1E is an example in which the pulverization process in the pulverizing step S20 is the wet pulverization process.

As shown in FIG. 1E, the method for producing a fluoride according to the first embodiment may further include a removing step S30.

The removing step S30 is performed after the pulverizing step S20. In the removing step S30, the solvent included in a pulverized product Pv obtained through the pulverizing step S20 is removed. According to the above configuration, the solvent can be removed from the fluoride whose particle diameter has been adjusted by the pulverizing step S20.

In the removing step S30, the solvent may be removed from the pulverized product Pv by drying under reduced pressure. The drying under reduced pressure is a method for removing a solvent from a pulverized product in a pressure atmosphere lower than the atmospheric pressure. The gauge pressure of the pressure atmosphere lower than the atmospheric pressure is, for example, −0.01 MPa or less. In the removing step S30, the solvent may be removed from the pulverized product Pv by vacuum drying.

The vacuum drying is a method for removing a solvent from a pulverized product at a pressure that is, for example, less than or equal to a vapor pressure at a temperature lower than the boiling point of the solvent by 20° C. The heating temperature of the pulverized product Pv in the drying under reduced pressure or the vacuum drying is, for example, 50° C. or more and 300° C. or less.

In the removing step S30, the solvent may be removed from the pulverized product Pv by heating the pulverized product Pv in an inert gas atmosphere. The heating temperature is, for example, 50° C. or more and 300° C. or less.

The fluoride produced by the method for producing a fluoride according to this embodiment may be used as a solid electrolyte material. The solid electrolyte material may be, for example, a solid electrolyte having lithium ion conductivity. The solid electrolyte material may be used, for example, in a battery (e.g., an all-solid-state secondary battery).

### OTHER EMBODIMENTS

### Appendix

The following techniques are disclosed by the description of the above embodiment.

### Technique 1

A method for producing a fluoride, the method including firing a mixture including a first ammonium salt containing Ti and F, a second ammonium salt containing Al and F, and having composition different from that of the first ammonium salt, and a lithium-containing compound in an inert gas atmosphere.

According to the method for producing a fluoride according to Technique 1, a fluoride can be produced by an industrially highly productive method.

### Technique 2

The method for producing a fluoride according to Technique 1, wherein a firing temperature in the firing is more than 150° C. and 600° C. or less. According to such a configuration, the materials included in the mixture can be sufficiently reacted, and hence the ionic conductivity of the fluoride can be enhanced. In addition, the thermal decomposition of the fluoride generated by a solid-phase reaction is suppressed. Accordingly, a high-quality fluoride can be obtained.

### Technique 3

The method for producing a fluoride according to Technique 1 or 2, wherein a firing temperature in the firing is 200° C. or more and 600° C. or less. According to such a configuration, the ionic conductivity of the fluoride can be further enhanced.

### Technique 4

The method for producing a fluoride according to any one of Techniques 1 to 3, further including pulverizing a fired product obtained through the firing. According to such a configuration, the particle diameter of the fluoride can be adjusted.

### Technique 5

The method for producing a fluoride according to Technique 4, wherein the fired product is pulverized in a solvent in the pulverizing, and the method further includes removing the solvent included in a pulverized product obtained through the pulverizing.

According to such a configuration, the solvent can be removed from the fluoride whose particle diameter has been adjusted by the pulverizing.

### Technique 6

The method for producing a fluoride according to any one of Techniques 1 to 5, wherein the first ammonium salt is represented by (NH₄)ₐTiFₐ₊₄, and the a satisfies 0<a≤2. According to such a configuration, the ionic conductivity of the fluoride can be enhanced. In addition, the production cost of the fluoride can be reduced.

### Technique 7

The method for producing a fluoride according to Technique 6, wherein the a satisfies a=2. According to such a configuration, the ionic conductivity of the fluoride can be further enhanced.

### Technique 8

The method for producing a fluoride according to any one of Techniques 1 to 7, wherein the second ammonium salt is represented by (NH₄)_{b}AlF_{b+3}, and the b satisfies 0<b≤3. According to such a configuration, the ionic conductivity of the fluoride can be enhanced. In addition, the production cost of the fluoride can be reduced.

### Technique 9

The method for producing a fluoride according to Technique 8, wherein the b satisfies b=3. According to such a configuration, the ionic conductivity of the fluoride can be further enhanced.

### Technique 10

The method for producing a fluoride according to any one of Techniques 1 to 9, wherein the lithium-containing compound includes at least one selected from the group consisting of lithium fluoride, lithium carbonate, and lithium nitrate. According to such a configuration, the ionic conductivity of the fluoride can be enhanced.

### Technique 11

The method for producing a fluoride according to any one of Techniques 1 to 10, wherein a firing temperature in the firing is 300° C. or more and 550° C. or less. According to such a configuration, the ionic conductivity of the fluoride can be still further enhanced.

### Technique 12

The method for producing a fluoride according to Technique 5, wherein a specific dielectric constant of the solvent is 2 or more and 70 or less. According to such a configuration, a high-quality fluoride can be obtained.

### Technique 13

The method for producing a fluoride according to Technique 5, wherein the solvent includes at least one selected from the group consisting of y-butyrolactone, propylene carbonate, butyl acetate, and tetralin. According to such a configuration, the ionic conductivity of the fluoride can be enhanced.

### Technique 14

The method for producing a fluoride according to any one of Techniques 1 to 13, wherein a fired product obtained through the firing includes Li₂TiF₆. According to such a configuration, the ionic conductivity of the fluoride can be enhanced.

### Technique 15

The method for producing a fluoride according to any one of Techniques 1 to 14, further including synthesizing the first ammonium salt before the firing. According to such a configuration, the production cost of the fluoride can be reduced.

### Technique 16

The method for producing a fluoride according to Technique 15, wherein in the synthesis, the first ammonium salt represented by (NH₄)ₐTiFₐ₊₄ is synthesized by a reaction between TiO₂ and NH₄F, and the a satisfies 0<a≤2. According to such a configuration, the production cost of the fluoride can be reduced.

### Technique 17

The method for producing a fluoride according to any one of Techniques 1 to 16, further including synthesizing the second ammonium salt before the firing. According to such a configuration, the production cost of the fluoride can be reduced.

### Technique 18

The method for producing a fluoride according to Technique 17, wherein in the synthesis, the second ammonium salt represented by (NH₄)_{b}AlF_{b+3} is synthesized by a reaction between Al₂O₃ and NH₄F, and the b satisfies 0<b≤3. According to such a configuration, the production cost of the fluoride can be reduced.

### EXAMPLES

Hereinafter, the present disclosure will be described in more detail with reference to examples. The following is an example and does not limit the present disclosure. In the following examples, a fluoride produced by the production method of the present disclosure is produced and evaluated as a solid electrolyte material.

### (Preparation of Fired Products)

### Sample 1

First, (NH₄)₂TiF₆ serving as a first ammonium salt and (NH₄)₃AlF₆ serving as a second ammonium salt were synthesized. TiO₂ and NH₄F were prepared as raw materials for (NH₄)₂TiF₆ so that a molar ratio of TiO₂ to NH₄F was 1:6. These raw materials were mixed while being pulverized in an agate mortar. The resulting first mixed raw material was put into an alumina crucible, heated up to 150° C. in a nitrogen atmosphere, and fired for 2 hours at a firing temperature of 150° C. Thus, (NH₄)₂TiF₆ was obtained. Al₂O₃ and NH₄F were prepared as raw materials for (NH₄)₃AlF₆ so that a molar ratio of Al₂O₃ to NH₄F was 1:12. These raw materials were mixed while being pulverized in an agate mortar. The resulting second mixed raw material was put into an alumina crucible, heated up to 150° C. in a nitrogen atmosphere, and fired for 2 hours at a firing temperature (atmosphere temperature) of 150° C. Thus, (NH₄)₃AlF₆ was obtained.

Next, in an argon atmosphere with a dew point of −60° C. or lower, (NH₄)₂TiF₆, (NH₄)₃AlF₆, and LiF were prepared to have a molar ratio (NH₄)₂TiF₆:(NH₄)₃AlF₆:LiF of 0.3:0.7:2.7. These materials were mixed while being pulverized in an agate mortar. The resulting mixture was put into an alumina crucible, heated to 200° C. in a nitrogen atmosphere, and fired for 2 hours at a firing temperature (atmosphere temperature) of 200° C. Thus, a fired product of Sample 1 was obtained.

### Sample 2

A fired product of Sample 2 was obtained by the same method as that for Sample 1 except that the resulting mixture was put into an alumina crucible, heated to 250° C. in a nitrogen atmosphere, and fired for 2 hours at a firing temperature of 250° C.

### Sample 3

A fired product of Sample 3 was obtained by the same method as that for Sample 1 except that the resulting mixture was put into an alumina crucible, heated to 300° C. in a nitrogen atmosphere, and fired for 2 hours at a firing temperature of 300° C.

### Sample 4

A fired product of Sample 4 was obtained by the same method as that for Sample 1 except that the resulting mixture was put into an alumina crucible, heated to 350° C. in a nitrogen atmosphere, and fired for 2 hours at a firing temperature of 350° C.

### Sample 5

A fired product of Sample 5 was obtained by the same method as that for Sample 1 except that the resulting mixture was put into an alumina crucible, heated to 400° C. in a nitrogen atmosphere, and fired for 2 hours at a firing temperature of 400° C.

### Sample 6

A fired product of Sample 6 was obtained by the same method as that for Sample 1 except that the resulting mixture was put into an alumina crucible, heated to 500° C. in a nitrogen atmosphere, and fired for 2 hours at a firing temperature of 500° C.

### Sample 7

A fired product of Sample 7 was obtained by the same method as that for Sample 1 except that the resulting mixture was put into an alumina crucible, heated to 550° C. in a nitrogen atmosphere, and fired for 2 hours at a firing temperature of 550° C.

### Sample 8

A fired product of Sample 8 was obtained by the same method as that for Sample 1 except that the resulting mixture was put into an alumina crucible, heated to 600° C. in a nitrogen atmosphere, and fired for 2 hours at a firing temperature of 600° C.

### Sample 9

In an argon atmosphere with a dew point of −60° C. or lower, (NH₄)₂TiF₆, (NH₄)₃AlF₆, and Li₂CO₃ were prepared to have a molar ratio (NH₄)₂TiF₆:(NH₄)₃AlF₆:Li₂CO₃ of 0.3:0.7:1.35. These materials were mixed while being pulverized in an agate mortar. The resulting mixture was put into an alumina crucible, heated to 400° C. in a nitrogen atmosphere, and fired for 2 hours at a firing temperature of 400° C. Thus, a fired product of Sample 9 was obtained.

### Sample 10

In an argon atmosphere with a dew point of −60° C. or lower, (NH₄)₂TiF₆, (NH₄)₃AlF₆, and LiNO₃ were prepared to have a molar ratio (NH₄)₂TiF₆:(NH₄)₃AlF₆:LiNO₃ of 0.3:0.7:2.7. These materials were mixed while being pulverized in an agate mortar. The resulting mixture was put into an alumina crucible, heated to 400° C. in a nitrogen atmosphere, and fired for 2 hours at a firing temperature of 400° C. Thus, a fired product of Sample 10 was obtained.

### Sample 11

A fired product of Sample 11 was obtained by the same method as that for Sample 1 except that the resulting mixture was put into an alumina crucible, heated to 150° C. in a nitrogen atmosphere, and fired for 2 hours at a firing temperature of 150° C.

### (X-Ray Diffraction Measurement of Fired Product)

The fired products of Samples 1 to 11 were each put into an agate mortar and pulverized. An X-ray diffraction pattern was measured for each fired product by the following method. An X-ray diffractometer (MiniFlex600 manufactured by Rigaku Corporation) was used in the evaluation of the crystal structure of the fired product.

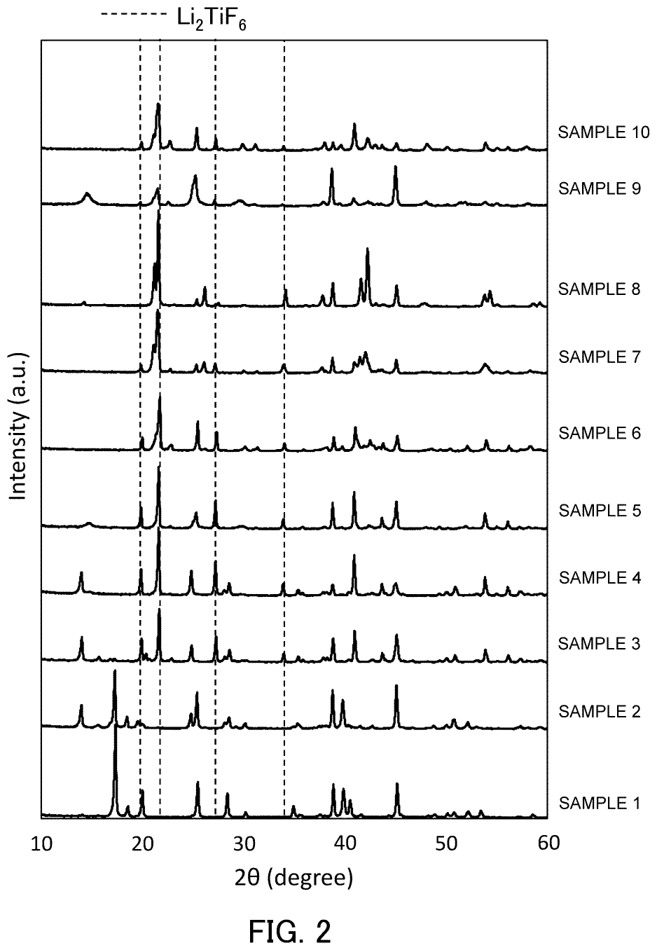

Through use of this apparatus, in a dry environment with a dew point of −50° C. or lower, the X-ray diffraction patterns of the powders of the fired products of Samples 1 to 11 were measured. A Cu-Ka radiation was used as an X-ray source. That is, the X-ray diffraction patterns were measured by a θ-2θ method using a Cu-Kα radiation (wavelengths of 1.5405 Å and 1.5444 Å) as an X-ray. FIG. 2 shows the X-ray diffraction patterns of the powders of the fired products of Samples 1 to 10.

In FIG. 2, four dashed lines indicate the positions of diffraction peaks originating from Li₂TiF₆. As shown in FIG. 2, all of the four diffraction peaks originating from Li₂TiF₆ were observed for each of the powders of the fired products of Samples 3 to 7, and Samples 9 and 10. Meanwhile, not all of the four diffraction peaks originating from Li₂TiF₆ were observed for each of the powders of the fired products of Samples 1 and 2, and Sample 8. That is, a fired product including a Li₂TiF₆ phase was easily obtained when the firing temperature was more than 200° C. and 550° C. or less, and the fired product including the Li₂TiF₆ phase was more easily obtained when the firing temperature was 300° C. or more and 550° C. or less.

Although not shown, not all of the four diffraction peaks originating from Li₂TiF₆ were observed for the powder of the fired product of Sample 11.

### (Production of Fluoride)

0.5 g of each of the fired products of Samples 1 to 11 was prepared. 14 g of γ-butyrolactone was prepared as a solvent. These materials were put into a pulverizing pot of a planetary ball mill (PULVERISETTE 7 manufactured by Fritsch Corporation) and lightly stirred with a spatula. Further, 5 g of media for pulverization were put into the pulverizing pot of the planetary ball mill. Zirconia balls each having a diameter of 0.5 mm were used as the media for pulverization. The fired products were each pulverized under the conditions of 500 rpm for 24 hours. Thereafter, the media for pulverization were separated from the pulverized product with a sieve having an opening of 212 pm. The separated pulverized product was put into a glass sealed beaker. While a nitrogen gas was flowed into the sealed beaker at 10 L/min, the pulverized product was heated up to 250° C. and heated at 250° C. for 2 hours. In this manner, the solvent was removed from the pulverized product. Thus, fluorides of Samples 1 to 11 were obtained.

### (Evaluation of Ionic Conductivity)

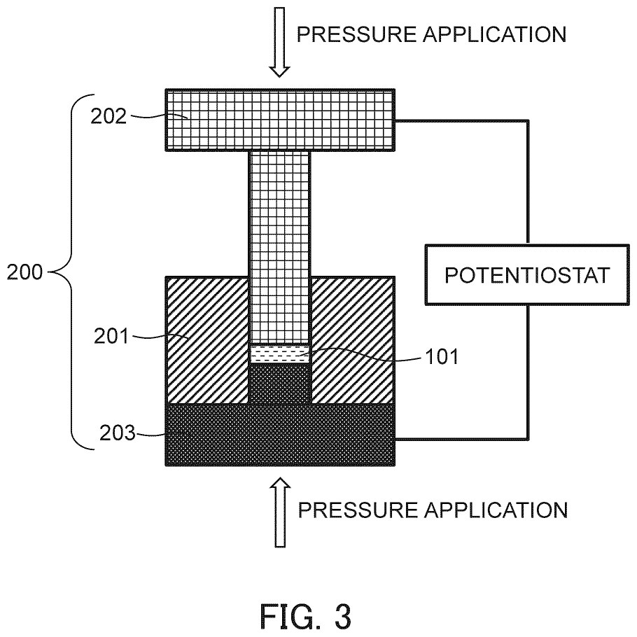

FIG. 3 is a schematic view for illustrating a pressure-molding die 200 used to evaluate the ionic conductivity of a fluoride. The pressure-molding die 200 included a die 201, an upper punch 202, and a lower punch 203. The die 201 was formed of electron-insulating polycarbonate. The upper punch 202 and the lower punch 203 were each formed of electron-conductive stainless steel.

The ionic conductivity of each of the fluorides of Samples 1 to 11 was measured by the following method using the pressure-molding die 200 illustrated in FIG. 3.

A powder 101 of the fluoride was loaded into the pressure-molding die 200 in a dry atmosphere with a dew point of −60° C. or lower. A pressure of 300 MPa was uniaxially applied to the powder 101 of the fluoride with the upper punch 202 and the lower punch 203. While the pressure was applied, the upper punch 202 and the lower punch 203 were connected to a potentiostat equipped with a frequency response analyzer (VersaSTAT4 manufactured by Princeton Applied Research Corporation). The upper punch 202 was connected to a working electrode and a terminal for potential measurement. The lower punch 203 was connected to a counter electrode and a reference electrode. An impedance of the powder 101 of the fluoride was measured by an electrochemical impedance measurement method at room temperature (25° C.).

Table 1 shows the ionic conductivity of each of the powders of the fluorides of Samples 1 to 11 together with the firing temperature and the like.

TABLE 1

| | Firing | Lithium- | Presence/absence | Ionic |
|---|---|---|---|---|
| | temperature | containing | of Li₂TiF₆ in fired | conductivity |
| | (° C.) | compound | product | (μS/cm) |
| Sample 1 | 200 | LiF | Absent | 1.7 × 10⁻³ |
| Sample 2 | 250 | LiF | Absent | 1.1 × 10⁻³ |
| Sample 3 | 300 | LiF | Present | 1.0 × 10⁰ |
| Sample 4 | 350 | LiF | Present | 1.5 × 10⁰ |
| Sample 5 | 400 | LiF | Present | 1.0 × 10⁰ |
| Sample 6 | 500 | LiF | Present | 2.8 × 10⁻¹ |
| Sample 7 | 550 | LiF | Present | 2.2 × 10⁻¹ |
| Sample 8 | 600 | LiF | Absent | 5.0 × 10⁻³ |
| Sample 9 | 400 | Li₂CO₃ | Present | 2.5 × 10⁻² |
| Sample 10 | 400 | LiNO₃ | Present | 3.2 × 10⁻¹ |
| Sample 11 | 150 | LiF | Absent | 2.1 × 10⁻⁴ |

### Discussion

As shown in Table 1, the fluorides of Samples 1 to 10 each exhibited a high ionic conductivity of 1.1×10⁻³ μS/cm or more at room temperature. This is conceived to be because the firing temperature in the firing step was more than 150° C. and 600° C. or less, and hence the mixture including the first ammonium salt, the second ammonium salt, and the lithium-containing compound was sufficiently subjected to a reaction. In contrast, the fluoride of Sample 11 exhibited a low ionic conductivity of 2.0×10⁻⁴ μS/cm at room temperature. This is conceived to be because the firing temperature in the firing step was 150° C., and hence the reaction of the mixture was insufficient.

The fluorides of Samples 3 to 7, and Samples 9 and 10 each exhibited a particularly high ionic conductivity of 2.5×10⁻² μS/cm or more at room temperature. This is conceived to be because the firing temperature in the firing step was more than 200° C. and 550° C. or less, and hence Li₂TiF₆ was easily generated.

As can be seen from the above results, according to the production method of the present disclosure, a fluoride was able to be produced by an industrially highly productive method. Specifically, the fluoride was able to be produced by using relatively inexpensive and highly available materials such as the first ammonium salt containing Ti and F, and the second ammonium salt containing Al and F, and by a simple method. Therefore, according to the production method of the present disclosure, a large amount of the fluoride can be produced at low cost. Further, the fluoride produced by the production method of the present disclosure can have a high lithium ion conductivity.

### INDUSTRIAL APPLICABILITY

The production method of the present disclosure may be used, for example, as a method for producing a solid electrolyte material. In addition, the solid electrolyte material produced by the production method of the present disclosure may be used, for example, in a battery (e.g., an all-solid-state secondary battery).

What is claimed is:

1. A method for producing a fluoride, the method comprising firing a mixture, which includes a first ammonium salt containing Ti and F, a second ammonium salt containing Al and F, and having composition different from that of the first ammonium salt, and a lithium-containing compound, in an inert gas atmosphere.

2. The method for producing a fluoride according to claim 1, wherein
a firing temperature in the firing is more than 150° C. and 600° C. or less.

3. The method for producing a fluoride according to claim 1, wherein
a firing temperature in the firing is 200° C. or more and 600° C. or less.

4. The method for producing a fluoride according to claim 1, further comprising pulverizing a fired product obtained through the firing.

5. The method for producing a fluoride according to claim 4, wherein
the fired product is pulverized in a solvent in the pulverizing, and
the method further comprises removing the solvent included in a pulverized product obtained through the pulverizing.

6. The method for producing a fluoride according to claim 1, wherein
the first ammonium salt is represented by (NH₄)ₐTiFₐ₊₄, and
the a satisfies 0<a≤2.

7. The method for producing a fluoride according to claim 6, wherein the a satisfies a=2.

8. The method for producing a fluoride according to claim 1, wherein
the second ammonium salt is represented by (NH₄)_{b}AlF_{b+3}, and
the b satisfies 0<b≤3.

9. The method for producing a fluoride according to claim 8, wherein
the b satisfies b=3.

10. The method for producing a fluoride according to claim 1, wherein
the lithium-containing compound includes at least one selected from the group consisting of lithium fluoride, lithium carbonate, and lithium nitrate.

11. The method for producing a fluoride according to claim 1, wherein
a firing temperature in the firing is 300° C. or more and 550° C. or less.

12. The method for producing a fluoride according to claim 5, wherein
a specific dielectric constant of the solvent is 2 or more and 70 or less.

13. The method for producing a fluoride according to claim 5, wherein
the solvent includes at least one selected from the group consisting of γ-butyrolactone, propylene carbonate, butyl acetate, and tetralin.

14. The method for producing a fluoride according to claim 1, wherein
a fired product obtained through the firing includes a Li₂TiF₆ phase.

15. The method for producing a fluoride according to claim 1, further comprising synthesizing the first ammonium salt before the firing.

16. The method for producing a fluoride according to claim 15, wherein
in the synthesizing, the first ammonium salt represented by (NH₄)ₐTiFₐ₊₄ is synthesized by a reaction between TiO₂ and NH₄F, and
the a satisfies 0<a≤2.

17. The method for producing a fluoride according to claim 1, further comprising synthesizing the second ammonium salt before the firing.

18. The method for producing a fluoride according to claim 17, wherein
in the synthesizing, the second ammonium salt represented by (NH₄)_{b}AlF_{b+3} is synthesized by a reaction between Al₂O₃ and NH₄F, and
the b satisfies 0<b≤3.
